(19) United States
(12) Patent Application Publication
(10) Pub. No.: US 2009/0266833 A1
(43) Pub. Date: Oct. 29, 2009

(54) Mobile storage apparatus

(76) Inventors: Stephen A. Savage, Essexville, MI (US); Robert A. Schmidt, Bay City, MI (US)

Correspondence Address: JOHN MCCULLOCH, 5291 COLONY DRIVE NORTH,, STE. 1, SAGINAW, MI, 48638, US

(21) Appl. No.: 12/148,864

(22) Filed: Apr. 23, 2008

(51) Int. Cl. B65D 25/28; B65D 25/00; B62B 3/00

(52) U.S. Cl. 220/757; 220/772; 280/47.11; 220/752

(57) ABSTRACT

Mobile storage apparatus comprises a wheeled container for the storage of materials and a handle for facilitating the wheeling of the container across the ground or other supporting surface. The handle has extensible and retractable sections thereby enabling the handle, when in its extended condition, to provide hanging support for the contents of the container. The handle sections are hinged for rocking movements relative to one another to enable such handle sections to occupy any selected one of a number of angularly adjusted positions.

This invention relates to mobile storage apparatus of the kind having a container provided with wheels and a handle by means of which the container may be wheeled across the ground or any other supporting surface.

### BACKGROUND OF THE INVENTION

It is customary to provide storage apparatus, similar to a trunk or large suitcase, in which garments, accessories, and other materials may be stored for travel. In those instances in which the storage apparatus is intended for use by performers, such as dancers, who require costume changes during a performance, it is customary to store costumes and related gear in a mobile container which may be wheeled to and from the desired site. Once the container is at the appropriate site, the costumes and other materials may be withdrawn from the container so as to minimize the crushing or wrinkling of the costumes. After the costumes are withdrawn from the container, however, it sometimes is difficult or awkward to hang the garments in such manner as to have ready access thereto while still giving the garments a chance to recover from being folded and packed in the container.

A principal object of the present invention is to provide mobile storage apparatus which overcomes the problems referred to above.

### SUMMARY OF THE INVENTION

Mobile storage apparatus according to the invention comprises a container having walls defining a hollow chamber in which costumes and other articles and garments may be stored for subsequent use. The container preferably includes a pair of ground engageable wheels and a handle by means of which the container may be wheeled across the ground or other support surface to a selected site. The container has a lid which may be opened to provide access to the interior of the chamber, thereby enabling individual garments and other articles to be withdrawn from the chamber.

The handle by means of which the container may be wheeled from one place to another includes two telescoping sections coupled together in such manner that one of them may be adjusted from a retracted position to an extended position to facilitate moving the container from place to place. Such handle section may be extended to occupy a position in prolongation of the other handle section. In such extended position the handle section provides support for articles of clothing withdrawn from the container and hung on hangers.

The garment-supporting handle section is pivotable relative to the other handle section so as to enable the garments supported by the handle section either to overhang the container or be supported in a position to one side of the container. To guard against the possibility that the container may tip when the garments are supported in a position at one side of the container, an auxiliary stabilizing support is provided. The auxiliary stabilizing support is extendible and retractable so as not to interfere with the mobility of the container.

### THE DRAWINGS

Apparatus constructed in accordance with the preferred embodiment of the invention is illustrated in the accompanying drawings wherein:

FIG. 1 is an isometric view of mobile storage apparatus wherein one of two telescoping handle sections is extended;

FIG. 2 is a view similar to FIG. 1, but illustrating both of the two handle section in extended positions;

FIG. 3 is a fragmentary, isometric view on an enlarged scale of the pivotal connection between the two handle sections;

FIG. 4 is a fragmentary, isometric view on an enlarged scale of the free end of one of the extendible handle sections;

FIG. 5 is a side elevational view illustrating the positions of the parts when the container is conditioned for towing across a supporting surface;

FIG. 6 is a side elevational view illustrating both of the two handle sections in extended, upright positions and an auxiliary stabilizing support; and

FIG. 7 is a view similar to FIG. 6 but illustrating the two handle sections in extended positions and indicating how articles may be supported in two different positions relative to the storage container.

### THE PREFERRED EMBODIMENT

Mobile wheeled storage apparatus constructed in accordance with the invention is designated generally by the reference character 1 and comprises a hollow container 2 having spaced, parallel sidewalls 3, a front wall 4, a rear wall 5, and a bottom wall (not shown) which, together, form a storage chamber. The container also has a top wall 6 provided with an opening that normally is closed by a lid 7 rockable between closed and open positions via a hinge 8.

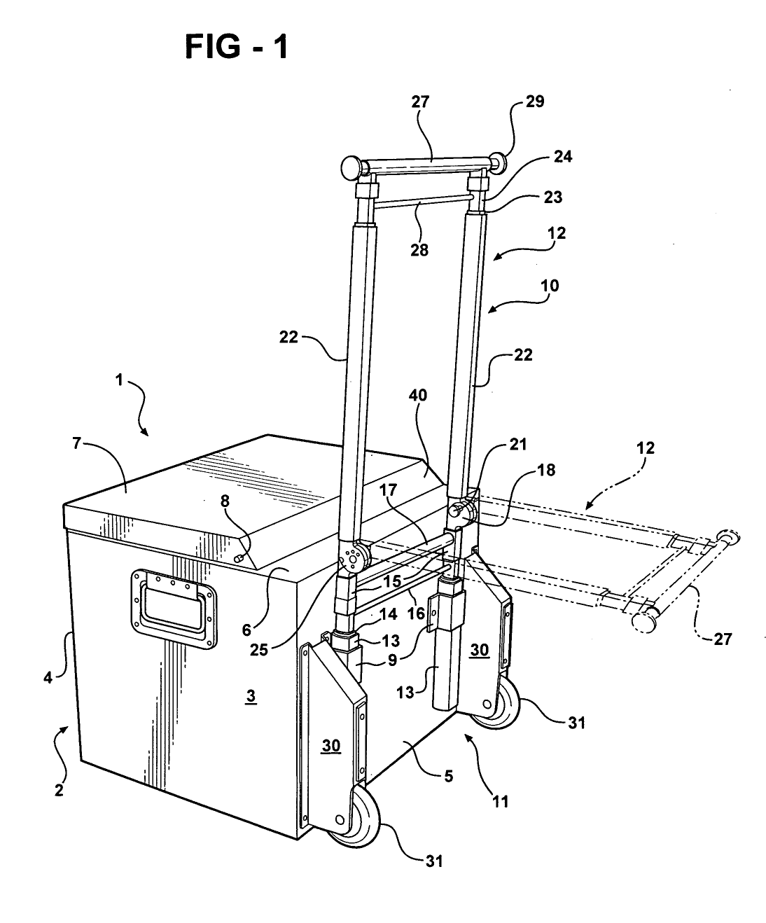

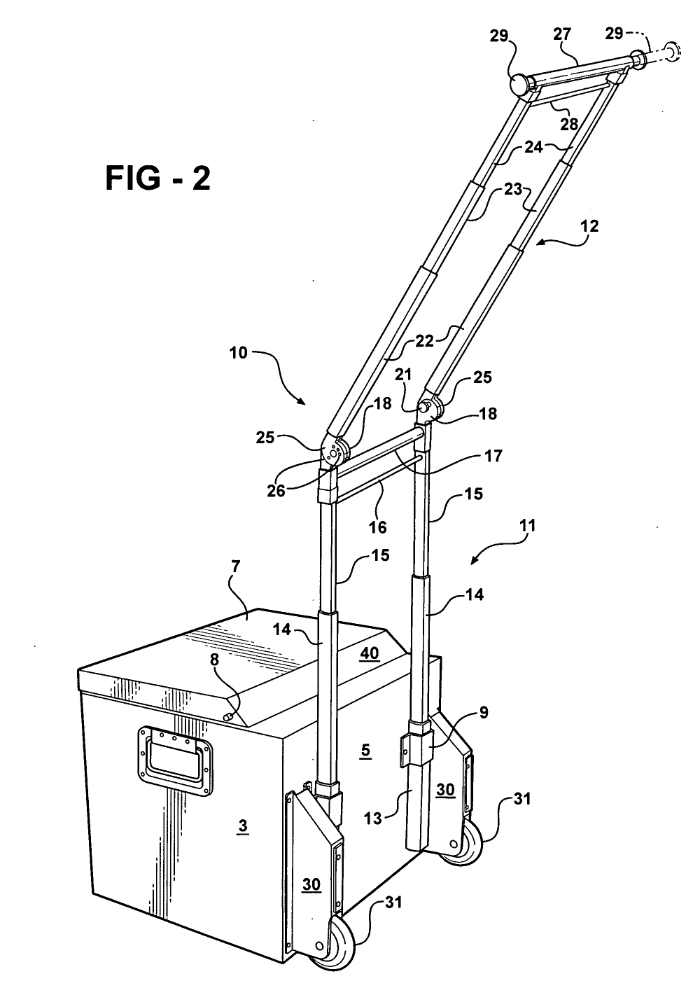

Secured to the rear wall 5 by brackets 9 is a handle assembly designated generally by the reference character 10 and comprising a pair of telescoping and relatively rotatable sections 11 and 12. The section 11 has sockets 13 within which are telescoped tubes or rods 14 and 15. The positions of the rods 14 and 15 is controlled by a squeeze operating bar 16 which is spring biased to an inactive position as shown in FIG. 1, but which is movable manually toward a cross bar 17 which joins the two rods 15 and maintains them in spaced apart condition. The handle section 11 is one that may be obtained from Clipper Products, Inc., of Cincinnati, Ohio and which is designated by the notation TS65. Such handle section is only one of many extensible and retractable handle units which may be used.

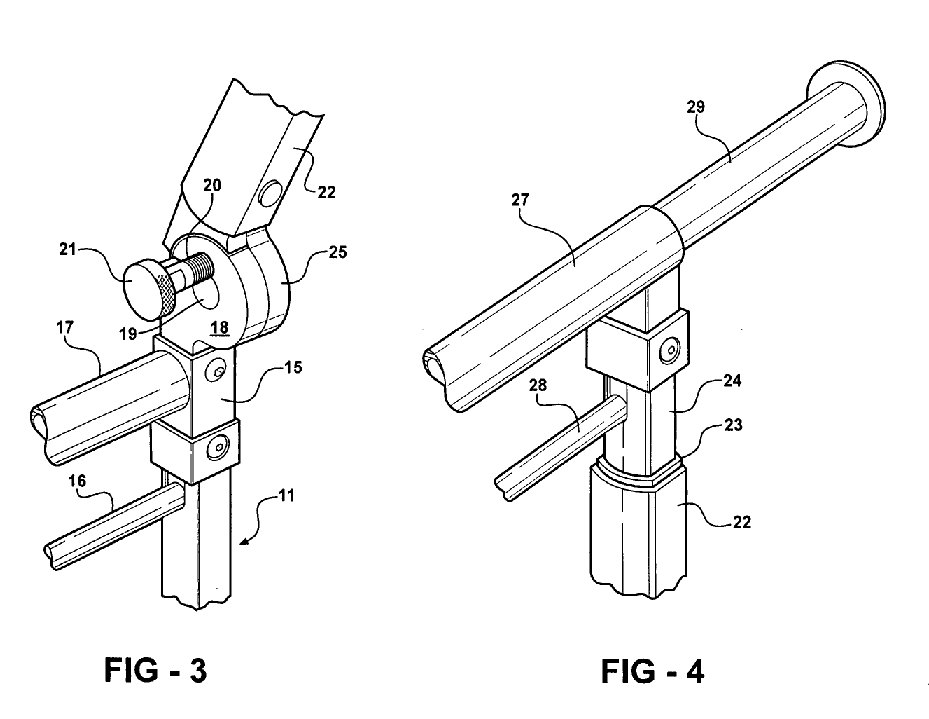

As is best shown in FIG. 3, the upper end of each tube or rod 15 terminates in a cylindrical bracket 18 having an opening extending therethrough in which is accommodated a pivot pin 19. The bracket also has an opening through which extends the shank 20 of a latch pin 21.

Forming a part of the handle assembly 10 is the second handle unit 12 which has a plurality of telescoping sections 22, 23, and 24 which correspond to the sections 13-15 of the unit 11. At those ends of the sections 22 which confront the upper end of the handle unit 11, is a hinge member 25 which lies adjacent the hinge member 18. The hinge member 25 has a plurality of openings 26 any one of which may accommodate the stem 20 of the latch pin 21 so as thereby to fix the handle unit 12 in any selected one of a number of angularly adjusted positions relative to the handle unit 11.

At the opposite or free end of the handle unit 12 is a cross bar or tube 27 which joins and maintains the telescoping sections 24 in spaced relation. At such end of the handle unit 12 is another squeeze actuating bar 28 which, like the squeeze bar 16, controls the means by which the telescoped sections 22-24 are enabled for and disabled from telescoping movement. The handle unit 12 also corresponds to the Clipper handle referred to above.

The cross bar 27 slideably accommodates extensions 29. The extensions 29 are extendible and retractable for a purpose presently to be explained.

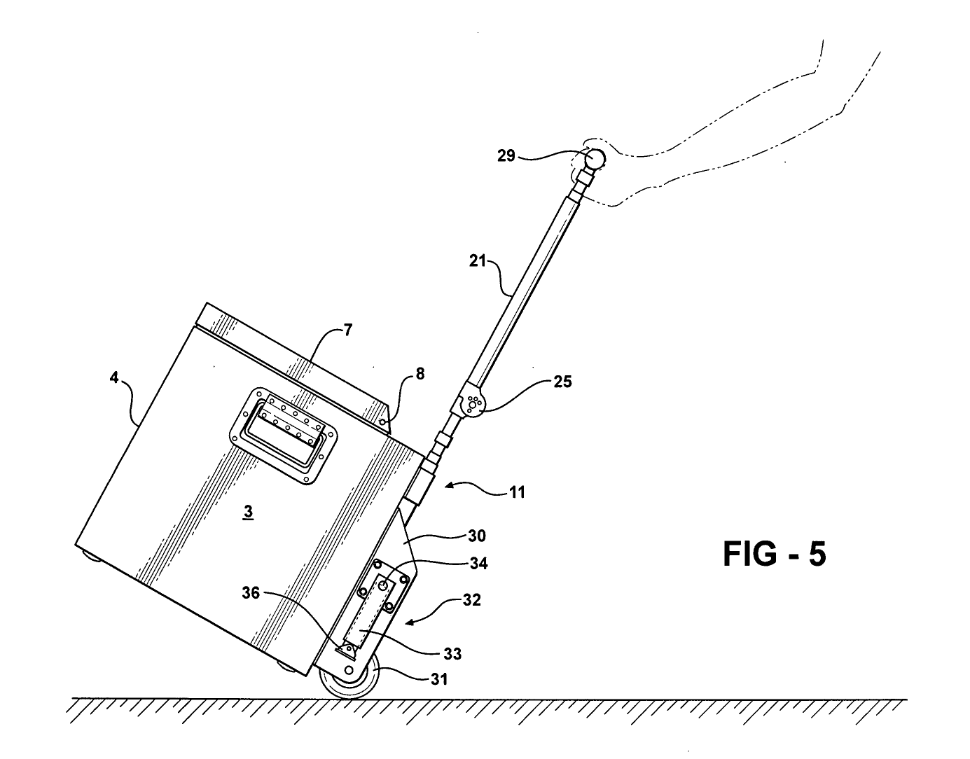

Secured to the rear wall 5 of the container is a pair of brackets 30 each of which supports a ground engageable wheel 31. The brackets and the wheels are so positioned relative to the container that, when the container is tipped, as is shown in FIG. 5, the wheels 31 will bear upon the ground or other surface and facilitate wheeling of the container across such surface by means of the handle unit 12.

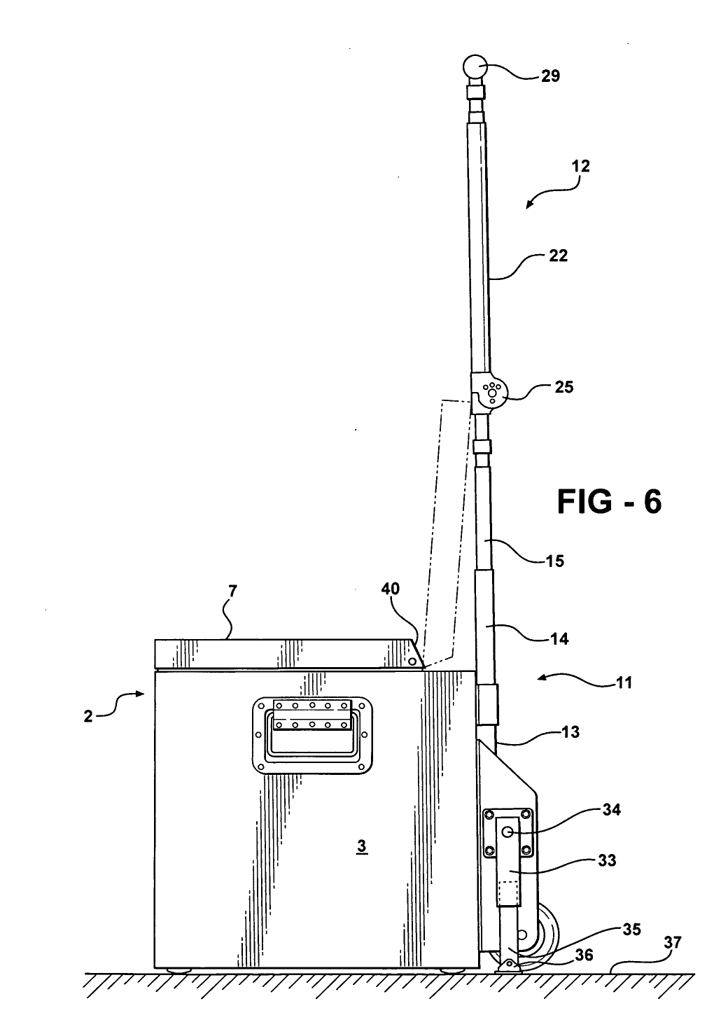

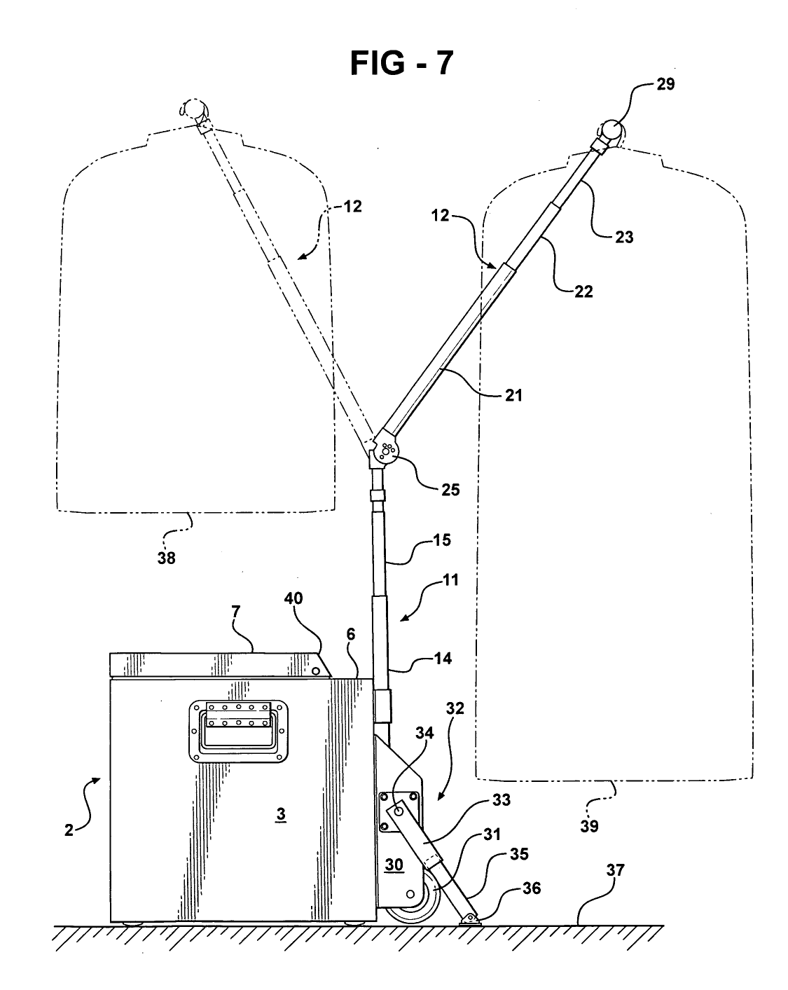

Each bracket 30 also optionally supports a stabilizer assembly 32 each of which comprises a sheath 33 pivoted as at 34 to the adjacent bracket 30 and accommodating a leg 35 which is extensible and retractable relative to the sheath and terminates at its free end in a pivoted foot 36. As is shown in FIGS. 6 and 7 the foot 36 may bear directly on the surface ground or support 37 by extending the leg 35, or the sheath 33 may be rocked about its pivotal axis 34 to enable the foot 36 to be extended laterally from the container 2 as is shown in FIG. 7 to inhibit tilting of the container. The stabilizing leg 35 may be maintained at any selected position of adjustment relative to the sheath 33 frictionally or by a conventional detent construction (not shown).

When the apparatus is not in use, the lid 7 of the container may be closed, the two handle sections 11 and 12 retracted, and the handle section 12 rocked relative to the handle section 11 about the pivot axis 19 from the upstanding, full line position shown in FIG. 1 through the chain line position shown in the same figure, and finally to a downwardly extended position 90° clockwise from the chain line position. This position of the handle assembly facilitates storing and stacking of the container.

When it is desired to use the apparatus, the lid 7 may be opened, thereby enabling access to the chamber within the container for the accommodation of costumes, clothing, and any other materials that may be desired. Thereafter, the lid may be closed and the handle section 12 rocked to the position shown in full lines in FIG. 1 and in FIG. 5 so as to facilitate a person's wheeling the container across the ground or other surface in the manner indicated in FIG. 5.

When the container reaches the site at which it is to be used, the handle sections 11 and 12 may be extended in prolongation of one another, as shown in FIG. 6, so that the cross bar 27 is uppermost. The lid 7 then may be opened. The rear edge 40 of the lid is chamfered so that the lid may be rocked rearwardly a distance sufficient to enable it to bear against the upstanding handle assembly and remain open, if desired, by gravity.

As the garments are withdrawn from the chamber of the container 2 they may be placed on hangers or in bags 38 or 39 and suspended from the extensions 29 which may be slid to their extended positions. If the garments or the bags 38 in which the garments are accommodated are fairly short, the handle assembly may be maintained in its vertically extended position shown in FIG. 7. If the garments or bags are sufficiently short, or if the weight of the articles to be suspended is so great as to risk tipping of the container, the handle assembly 12 may be swung to the position shown in chain lines in FIG. 7 so that the garments or garment bags 38 directly overhang the container. Accordingly, hanging space may be provided by the storage apparatus for the garments without requiring any lateral space other than that necessary to accommodate the container itself.

If it is desired to support the garments or garment bags in such position that no interference at all will be provided for access to the interior of the container, the handle section 12 may be swung to the position shown in full lines in FIG. 7 in which the garment bags 39 are spaced laterally to one side of the container. As shown in FIG. 7, the garment bags 39 are of greater length than the garment bags 38, but the lateral spacing of the garment bags 39 relative to the container ensures no wrinkling of the contents of the bags due to contact with the container.

In the event the weight of the materials suspended from the second hanger section 12 is sufficiently great to risk tilting of the container, the stabilizing apparatus 32 may be adjusted so that the leg 35 and the foot 36 are extended angularly into engagement with the surface 37 to enable the container to be braced against tilting due to the load of the garments bags 39 and their contents.

This disclosure is representative of a presently preferred form of the invention, but is intended to be illustrative rather than definitive thereof. The invention is defined in the claims.

We claim:

1. Mobile storage apparatus comprising a hollow container having side walls, a bottom wall, and a lid defining a storage chamber, said lid being movable between positions in which said lid respectively closes said chamber or enables access thereto; wheels mounted at one side of said container for enabling said container to be wheeled across a surface; and handle means connected to said container for facilitating the wheeling of said container across said surface, said handle means comprising a first handle section having telescoped extensible and retractable rods, a second handle section having telescoped extensible and retractable rod; and hinge means pivotally connecting said second handle section to said first handle section for enabling said second handle section to be adjusted angularly relative to said first handle section to a selected one of a plurality of angularly adjusted positions.

2. The apparatus according to claim 2 wherein said second handle section is rockable relative to said first handle section between a first position in which said second handle section overlies said container and a second position in which said second handle section extends laterally away from and to one side of said container.

3. The apparatus according to claim 1 wherein said second handle section may occupy a third position in prolongation of said first handle section.

4. The apparatus according to claim 1 including latch means cooperable between said first and second handle sections for latching said second handle section in any selected one of said positions.

5. The apparatus according to claim 1 wherein said second handle section has a free end at which is a tubular cross member, and extensions slideably accommodated in said cross member for movements between extended and retracted positions relative to said cross member.

6. The apparatus according to claim 1 including adjustable stabilizing means carried by said container for adjustment into and out of ground engagement for inhibiting undesirable tilting of said container.

7. The apparatus according to claim 6 wherein said stabilizing means comprises a sheath mounted on said container and an extensible and retractable leg carried by said sheath, said leg having a free ground engageable end.

8. Mobile storage apparatus comprising a hollow housing having walls defining a storage chamber; a pair of ground engageable wheels mounted on one wall of said housing for enabling said housing to be wheeled across a surface; handle means mounted on said housing for movements from a retracted position to an extended position in which wheeled movement of said housing across said surface is facilitated, said handle means comprising a first handle section formed by a plurality of telescoping rods, a second handle section formed by a plurality of telescoping rods, and hinge means rockably connecting said first and second handle sections to one another for rocking movements of said second handle section relative to said first handle section.

9. The apparatus according to claim 8 including latch means for latching said second handle section in any selected one of a number of angularly adjusted positions relative to said first handle section.

10. The apparatus according to claim 9 including latch means for latching said second handle section in said selected adjusted position.

11. The apparatus according to claim 8 wherein one of said adjusted positions is a position in which said second handle means overlies said container.

12. The apparatus according to claim 8 wherein one of said adjusted positions is a position in which said second handle section extends laterally beyond said container.

13. The apparatus according to claim 8 wherein one of said adjusted positions is a position in which said second handle section extends in prolongation from said first handle section.

14. The apparatus according to claim 8 including adjustable stabilizing means carried by said container for adjustment into and out of ground engagement for inhibiting undesirable tilting of said container.

15. The apparatus according to claim 8 wherein said second handle section has a free end at which is a tubular cross member, and extensible and retractable rods slideably accommodated in said cross member for movements between extended and retracted positions.

16. A handle assembly comprising a first unit having telescoping extensible and retractable members; a second unit having telescoping extensible and retractable members; and pivotal means coupling one end of said first unit to one end of said second unit and forming an axis about which said second unit is rockable relative to said first unit.

17. The assembly according to claim 16 wherein said second unit is rockable about said axis from a first position in prolongation of said first unit to a selected position angularly displaced from said first position.

18. The assembly according to claim 16 including latch means operable to latch said second unit in any selected one of a number of angularly adjusted positions.

19. The assembly according to claim 16 wherein said second unit is rockable about said axis from the first position in prolongation of said first unit to a selected position angularly displaced in either one of two opposite directions from said first position.

20. The assembly according to claim 16 wherein said second unit has a free end formed by a tube, and extensions slideably accommodated in said tube for independent extension therefrom in opposite directions.
